(19) United States
(12) Patent Application Publication
(10) Pub. No.: US 2020/0139279 A1
(43) Pub. Date: May 7, 2020

(54) EASY TO SERVICE FILTER ASSEMBLY

(71) Applicant: WHIRLPOOL CORPORATION, Benton Harbor, MI (US)

(72) Inventor: Narendra A. Kapure, Pune (IN)

(73) Assignee: WHIRLPOOL CORPORATION, Benton Harbor, MI (US)

(21) Appl. No.: 16/177,484

(22) Filed: Nov. 1, 2018

(51) Int. Cl. B01D 35/30; B01D 35/02; B01D 35/157; F25D 23/12; C02F 1/00

(52) U.S. Cl. CPC B01D 35/306; B01D 35/02; B01D 35/1573; F25D 23/126; C02F 2307/12; B01D 2201/56; B01D 2201/4023; B01D 2201/16; F25D 2323/121; C02F 1/003

(57) ABSTRACT

A water filter assembly includes a filter cartridge, a Wi-Fi module, and a valve attached to a water filter housing. The water filter housing includes a base portion with a number of retention tab receivers that engage retention tabs that are inserted into retention tab openings in an exterior surface of the refrigerator.

### BACKGROUND

The present disclosure generally relates to a water filter assembly for use with a refrigerator, and more specifically to a water filter assembly that can be easily removed for service of the components of a water filter assembly.

Various types of water filters have been developed for use with a variety of appliances. For example, water filters are commonly in used in refrigerators. Problems exist with such water filter assemblies as they are typically located inside the freezer/refrigerator compartment which leads to volume reduction within the compartment. Additionally, the filter housing and water valve are typically located at different locations which leads to an increase in service time/cost when portions of the water filter, line, valve, and/or cartridge need to be serviced. Thus, an easily serviced water filter assembly is desirable.

### BRIEF SUMMARY OF THE INVENTION

One aspect of the present invention is a refrigerator filter assembly that is attached to a refrigerator. The refrigerator includes at least one retention tab opening that receives a retention tab. The retention tab has a plurality of radial protrusions, including at least one protrusion that engages a surface of a refrigerator in the area of the retention tab opening. The retention tab also includes a retention tab receiver engaging portion between two radial protrusions. A filter assembly housing, to which a filter unit can be removably coupled, includes a base portion with at least one retention tab receiver that is coupled to the refrigerator. The retention tab receiver has a tapered surface resulting in a narrow portion, the narrow portion configured to closely receive a surface of the retention tab receiver engaging portion of the retention tab.

Another aspect of the present invention includes a filter assembly. The filter assembly includes a base portion with at least one retention tab receiver configured for receiving a retention tab. The retention tab has a plurality of radial protrusions attached to an exterior surface of an appliance. The filter assembly also includes a generally cylindrical portion for receiving a filter unit. The filter assembly also includes a valve coupled to the filter assembly housing, and a Wi-Fi module coupled to the filter assembly housing. The retention tab receiver is spaced away from the bottom surface of the base portion to engage a portion of the retention tab that is between two of the radial protrusions of the retention tab.

Yet another aspect of the present invention is a method of installing a refrigerator filter assembly. At least one retention tab is installed into a retention tab opening in an exterior surface of the refrigerator cabinet. The retention tab includes a plurality of radial protrusions with at least one of the radial protrusions engaging a surface of the retention tab opening in the refrigerator cabinet. Two of the radial protrusions are spaced apart to form a retaining tab receiver engaging portion. The filter assembly is slid onto the exterior surface of the refrigerator cabinet to engage the retention tab receiving portions of the retention tab. A water filter is then installed into the water filter receiving portion of the base portion of the water filter assembly.

These and other features, advantages, and objects of the present disclosure will be further understood and appreciated by those skilled in the art upon studying the following specification, claims, and appended drawings.

### BRIEF DESCRIPTION OF THE DRAWINGS

In the drawings:

FIG. 1 is a top perspective view of one embodiment of a water filter assembly of the present invention installed on a refrigerator;

FIG. 2 is a top view of the water filter assembly shown in FIG. 1;

FIG. 3 is a front perspective view of the water filter assembly shown in FIG. 1;

FIG. 4 is an exploded front perspective view of the components of the water filter assembly shown in FIG. 1;

FIG. 5 is a top perspective view of the water filter assembly housing being installed on a refrigerator cabinet;

FIG. 6 is a top perspective view of the water filter assembly housing installed on a refrigerator cabinet;

FIG. 7 is top perspective view of a water filter cartridge being inserted into the water filter assembly housing shown in FIG. 6;

FIG. 8 is a top perspective view of the water filter assembly fully installed with a water filter cartridge on a refrigerator cabinet;

FIG. 9 is a cross-sectional view of a retaining tab used for holding the water filter assembly on a refrigerator cabinet;

FIG. 10 is a front perspective view of the base of the water filter assembly;

FIG. 11 is a top view of the water filter assembly base;

FIG. 12 is a cross-sectional view taken along lines XII-XII of FIG. 11 of the water filter assembly base; and

FIG. 13 illustrates the water filter assembly with the cover opened for installation and/or removal of the water filter cartridge.

### DETAILED DESCRIPTION OF THE PREFERRED EMBODIMENTS

As referenced in the figures, the same reference numerals may be used herein to refer to the same parameters and components or their similar modifications and alternatives. For purposes of description herein, the terms “upper,” “lower,” “right,” “left,” “rear,” “front,” “vertical,” “horizontal,” and derivatives thereof shall relate to the present disclosure as oriented in the Figures. However, it is to be understood that the present disclosure may assume various alternative orientations, except where expressly specified to the contrary. It is also to be understood that the specific devices and processes illustrated in the attached drawings, and described in the following specification are simply exemplary embodiments of the inventive concepts defined in the appended claims. Hence, specific dimensions and other physical characteristics relating to the embodiments disclosed herein are not to be considered as limiting, unless the claims expressly state otherwise. The drawings referenced herein are schematic and associated views thereof are not necessarily drawn to scale.

In this specification and the appended claims, the singular forms “a,” “an,” and “the” include plural reference unless the context clearly dictates otherwise.

For purposes of this disclosure, the term “coupled” (in all of its forms, couple, coupling, coupled, etc.) generally means the joining of two components (electrical or mechanical) directly or indirectly to one another, including, but not limited to, through the use of fasteners, other mechanical fasteners, adhesives, etc. Such joining may be stationary in nature or movable in nature. Such joining may be achieved with the two components (electrical or mechanical) and any additional intermediate members being integrally formed as a single unitary body with one another or with the two components. Such joining may be permanent in nature or may be removable or releasable in nature unless otherwise stated.

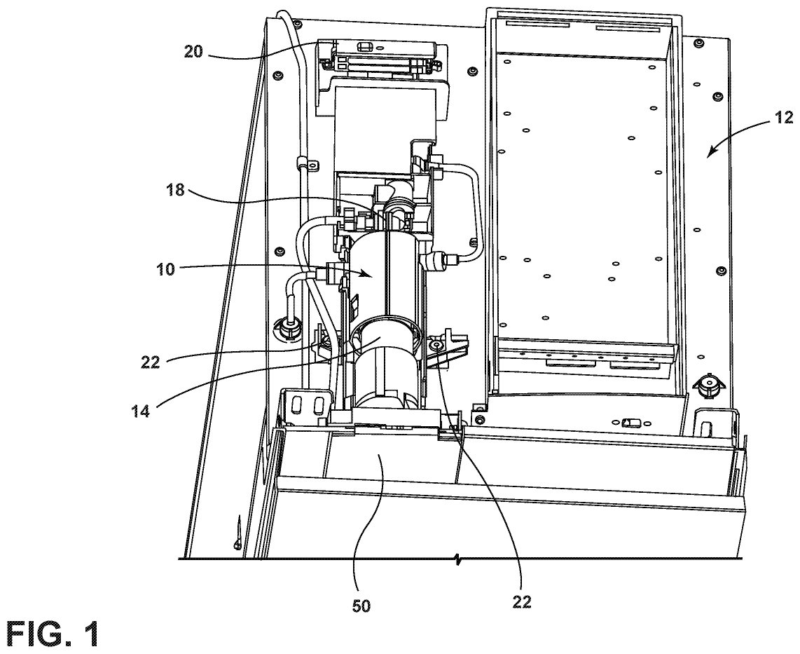

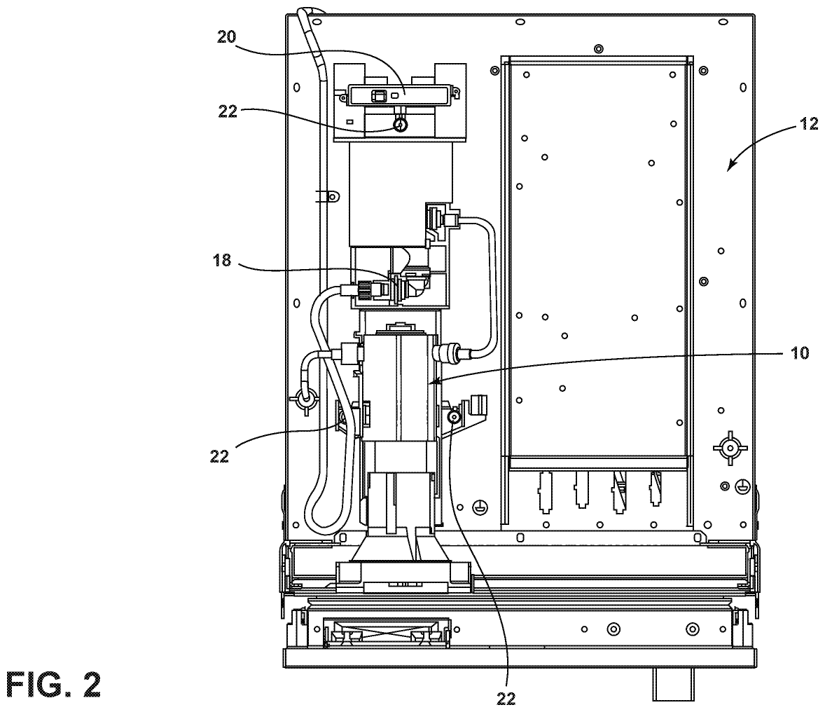

Referring to the embodiment illustrated in FIGS. 1-4, the reference numeral 10 generally designates a water filter assembly that is used in connection with a refrigerator 12. The water filter assembly 10 can be a separate package that can be selectively added to the refrigerator 12 during and/or after manufacture. The filter assembly 10 may couple to any external surface of the refrigerator 12 such that the storage volume within the refrigerator 12 is not decreased by the water filter assembly 10. For example, in the illustrated embodiment shown in FIGS. 1, 2, and 5-8, the water filter assembly 10 is installed on the top of the cabinet of the refrigerator 12. Additionally, by locating the water filter assembly 10 on the external surface of the refrigerator 12, the water filter assembly 10 is easier to access. By making the water filter assembly 10 easier to access, the water filter assembly 10 is easier to assemble and disassemble for installation, service, and/or replacement. The water filter assembly 10 may include a water filter cartridge 14, a filter assembly housing 16, a valve 18, and a Wi-Fi module 20.

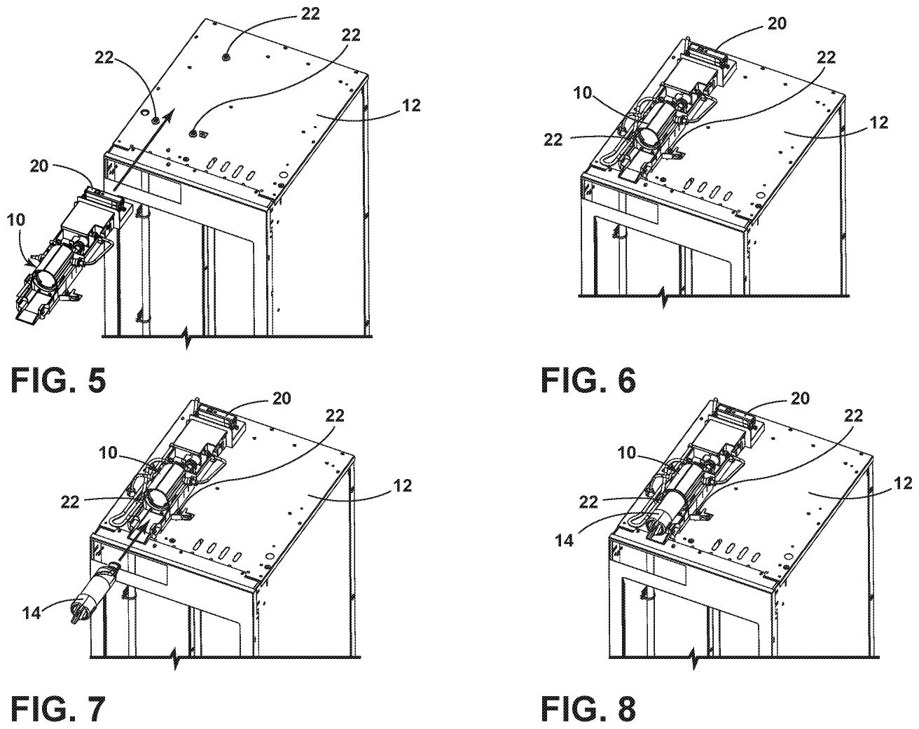

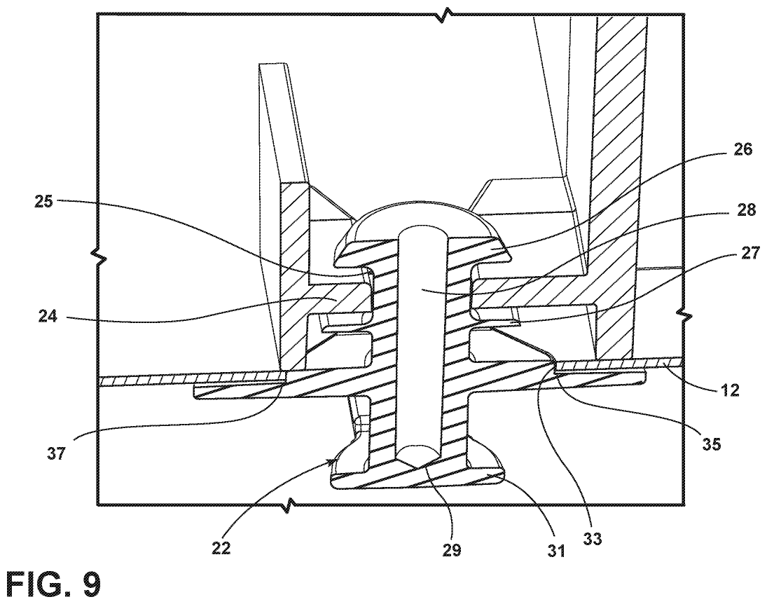

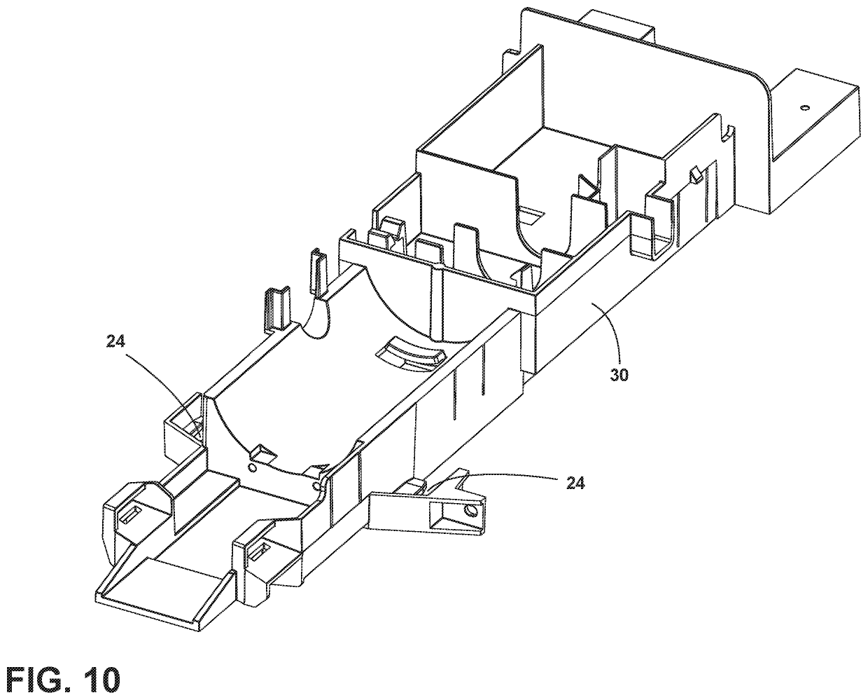

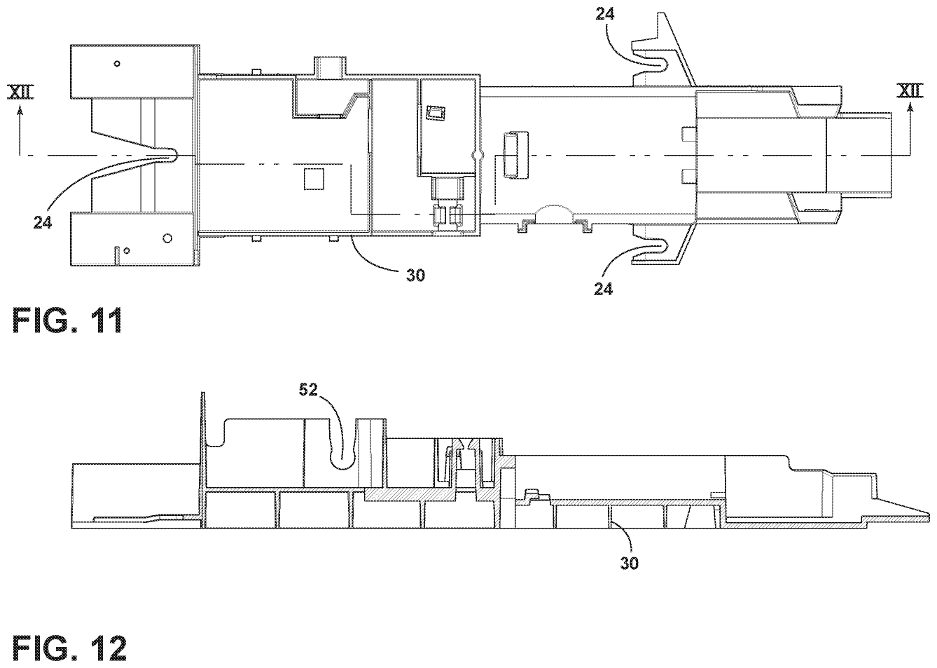

Referring to FIGS. 5-8, the water filter assembly 10 may slidably engage with one or more retention tabs 22 that are coupled to the cabinet of the refrigerator 12. As illustrated in FIG. 9, the retention tabs 22 are received in openings 37 in the refrigerator 12. Once the water filter assembly 10 is engaged with the retention tabs 22, the water filter assembly 10 may be additionally coupled to the refrigerator 12 by one or more fasteners, such as screws or bolts. The water filter assembly 10 may be equipped with a water filter cartridge 14 prior to the coupling of the water filter assembly 10 to the refrigerator 12, or the water filter cartridge 14 may be inserted into the water filter assembly 10 after the water filter assembly 10 has been coupled to the refrigerator 12, as illustrated in FIGS. 6 and 7.

The water filter assembly 10 may couple to retention tabs 22 by engaging retention tabs 22 with a corresponding retention tab receivers 24 that are on the base 30 of the water filter housing 16. The retention tab receivers 24 on the water filter assembly 10 may be positioned on three sides of the water filter assembly 10, as illustrated in FIGS. 5-8. As illustrated in FIG. 9, the retention tabs 22 may include a plurality of radial extensions 31, 33 to engage with surfaces on the refrigerator 12. As illustrated in FIG. 9, one radial extension 33 can have a shoulder 35 to engage the opening in the cabinet of refrigerator 12. The retention tabs 22 can also have radial extension 26, 27, that define the retention tab receiver engaging portion 25 of the retention tabs 22. As illustrated in FIG. 9, the retention tab receiver engaging portion 25 of the retention tab 22 can be spaced away from the surface of the refrigerator 12.

As illustrated in FIG. 9, the radial extension 26 of the retention tab 22 can engage the upper surface of the base 30 of the filter assembly housing 16. The retention tab 22 may be equipped with a hollow center 28 to allow for at least some deformation of retention tabs 22 in order to facilitate installation of the water filter assembly 10 to the cabinet of the refrigerator 12. In the illustrated embodiment, the hollow portion 28 is a vertical aperture with a bottom 29. In addition, the aperture 28 could be a through-hole with no bottom 29, or the bottom 29 could be raised to make a smaller aperture. The retention tabs 22 may be deformed as a result of pressure of the surfaces of the retention tab receivers 24. This deformation may be temporary and/or permanent while the retention tabs 22 are first contacting and then engaging the retention tab receivers 24. The retention tabs 22 are made from a sturdy yet flexible material, such as polymeric materials, including plastics, rubber, and foam.

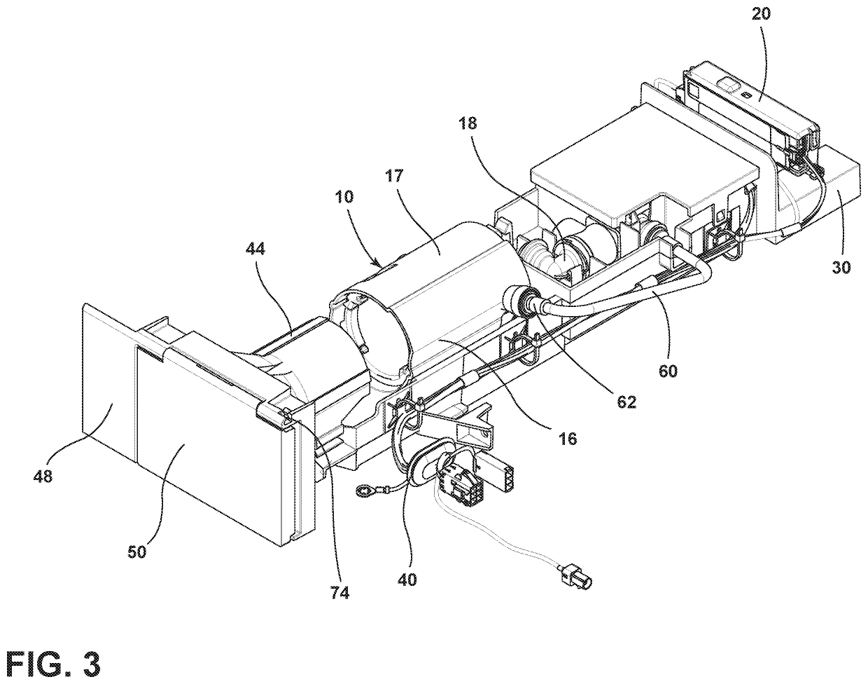

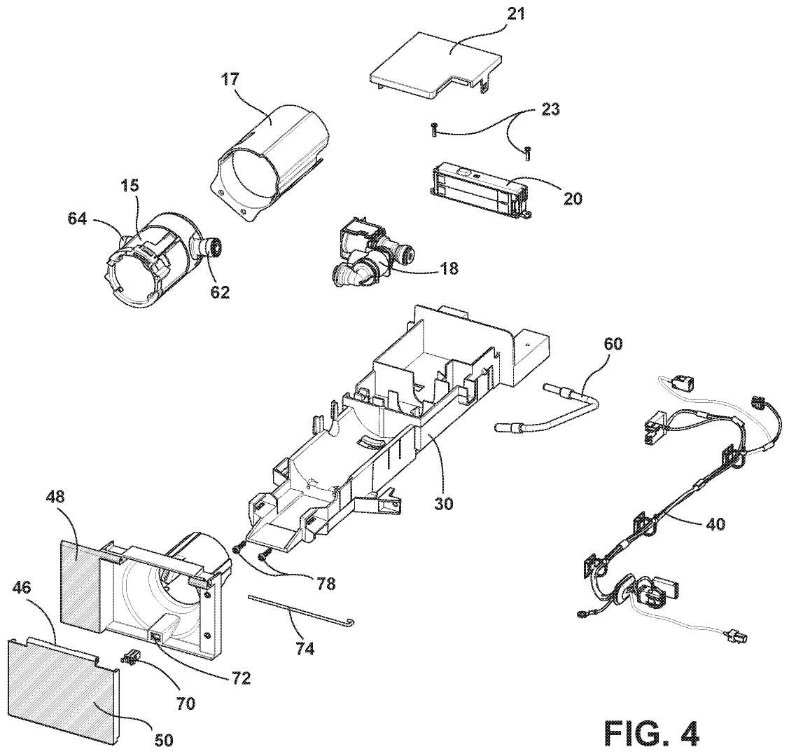

As illustrated in FIGS. 3 and 4, the water filter assembly 10 includes a filter assembly housing 16, a Wi-Fi module 20, a valve 18, and a wire harness 40. The Wi-Fi module 20 can be secured to the base 30 of the filter assembly housing 16 by fasteners 23. In addition, a cover 21 may be used over the Wi-Fi module 20. The Wi-Fi module 20 can be used to program and/or control features of the water filter assembly 10 and can provide feedback about the condition of the wire harness 40, valve 18, and water filter cartridge 14.

The filter assembly housing 16 includes a base 30 with the aforementioned retention tab receivers 24. A housing mount 17 for the water filter cartridge 14 is attached to the base 30. Fasteners 78 can be used to help secure the housing mount 17 to the base 30 once the water filter housing assembly 15 is positioned within the housing mount 17. The base 30 can include openings 52 for holding water lines 60 securely on the base 30.

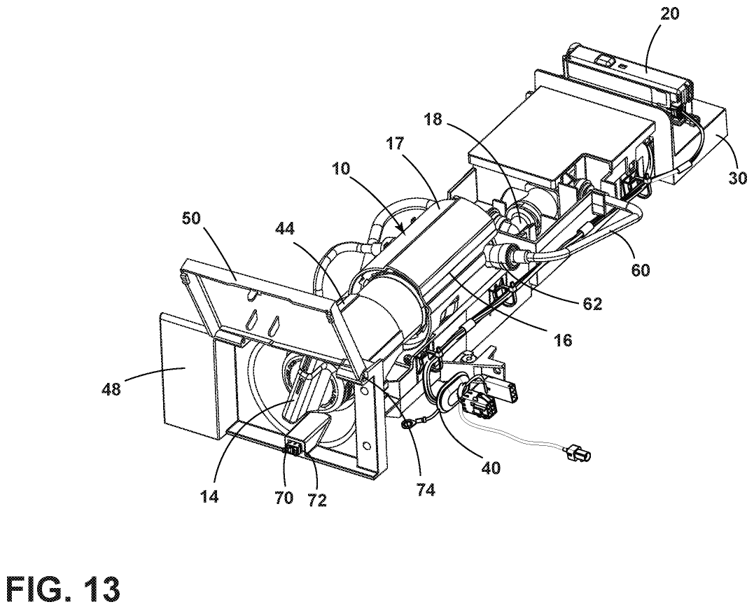

The water filter housing assembly 15 includes ports 62, 64 which engage water lines 60. The filter assembly housing 16 can include a plate 48, with a generally circular portion 44 which surrounds an installed filter cartridge 14, and a hinge 74 that couples to a hinge opening 46 on cover 50, as illustrated in FIG. 4. The cover 50 can be opened by pushing the cover 50 to release the push-push latch 70 that is attached to latch opening 72 in the plate 48. Opening of the cover 50 permits installation and/or removal of water filter cartridge 14, as illustrated in FIG. 13.

The valve 18 can be any type and/or number of valves capable of being controlled of the directional flow of water. In the illustrated example, the valve 18 is a single solenoid valve.

While not shown in the illustrated embodiments, fasteners may be used to secure the water filter assembly to the refrigerator 12 once the retention tabs 22 are retained in the retention tab receivers 24 in the base 30. The retention tab receivers 24 are tapered to have a width that is close to the width of the retention tab receiver engaging portion 25 of the retention tabs 22. This permits the base 30 to be held securely on the refrigerator 12. The flexibility of the retention tabs 22 permits the base 30 to be held securely on the refrigerator 12 even if the retention tab receiver 24 is slightly more narrow than the retention tab receiver engaging portion 25 of the retention tabs 22. The retention tab receivers 24 can include a generally circular shape that generally matches the shape of the retention tab receiver 24 such that the retention tab 22 is temporarily deformed and then permitted to partially or entirely expand once the retention tab receiver engaging portion 25 expands into the slightly larger area past the taper.

While the illustrated embodiments show three retention tabs 22 and three associated retention tab receivers 24, any number of retention tabs 22 and retention tab receivers 24 can be used to partially and/or entirely secure the water filter assembly 10 to the refrigerator 12. The retention tabs 22 and retention tab receivers 24 can be positioned in any arrangement on the refrigerator 12 and base 30 so long as they can partially and/or entirely couple the base 30 to the refrigerator 12.

It will be understood by one having ordinary skill in the art that the water filter assembly 10, as described herein, can be used with a variety of appliances, such as refrigerators, dishwashers, ovens, clothes washers, dryers, etc. Further, it will be understood that the water filter assembly 10 can be used for a variety of applications, such as a second stage water filter for the appliance. These are examples only and not meant to be limiting. While the description is considered that of the illustrated embodiments only. The above description is considered that of the illustrated embodiments only and modifications of the invention will occur to those of skill in the art and to those who make or use the invention. Therefore, it should be understood that the embodiment shown in the drawings and described above are merely for illustrative purposes and not intended to limit the scope of the invention, which is defined by the following claims as interpreted under the principles of patent law, including the doctrine of equivalents.

Those skilled in the art will recognize, or will be able to ascertain using no more than routine experimentation, many equivalents to the specific embodiments of the invention described herein. Such equivalents are intended to be encompassed by the following claims.

While the concepts of the present disclosure are susceptible to various modifications and alternative forms, specific exemplary embodiments thereof have been shown by way of example in the drawings and will herein be described in detail. It should be understood, however, that there is no intent to limit the concepts of the present disclosure to the particular forms disclosed, but on the contrary, the intention is to cover all modifications, equivalents, and alternatives falling within the spirit and scope of the invention as defined by the appended claims.

It will be understood by one having ordinary skill in the art that construction of the present disclosure and other components is not limited to any specific material. Other exemplary embodiments of the disclosure disclosed herein may be formed from a wide variety of materials, unless described otherwise herein.

It is also important to note that the construction and arrangement of the elements of the present disclosure as shown in the exemplary embodiments is illustrative only. Although only a few embodiments of the present innovations have been described in detail in this disclosure, those skilled in the art who review this disclosure will readily appreciate that, unless otherwise described, many modifications are possible (e.g., variations in sizes, dimensions, structures, shapes, and proportions of the various elements, values of parameters, mounting arrangements, use of materials, colors, orientations, etc.) without materially departing from the novel teachings and advantages of the subject matter recited. For example, elements shown as integrally formed may be constructed of multiple parts or elements shown as multiple parts may be integrally formed, the operation of the interfaces may be reversed or otherwise varied, the length or width of the structures and/or members or connector or other elements of the system may be varied, the nature or number of adjustment positions provided between the elements may be varied. It should be noted that the elements and/or assemblies of the system may be constructed from any of a wide variety of materials that provide sufficient strength or durability, in any of a wide variety of colors, textures, and combinations. Accordingly, all such modifications are intended to be included within the scope of the present innovations. Other substitutions, modifications, changes, and omissions may be made in the design, operating positions, and arrangement of the desired and other exemplary embodiments without departing from the spirit of the present innovations.

It will be understood that any described processes or steps within described processes may be combined with other disclosed processes or steps to form structures within the scope of the present disclosure. The exemplary structures and processes disclosed herein are for illustrative purposes and are not to be construed as limiting.

It is also to be understood that variations and modifications can be made on the aforementioned structures and methods without departing from the concepts of the present invention, and further it is to be understood that such concepts are intended to be covered by the following claims unless these claims by their language expressly state otherwise.

What is claimed is:

1. A refrigerator filter assembly comprising:
a refrigerator with at least one retention tab opening;
at least one retention tab, having a plurality of radial protrusions, coupled to said at least one retention tab opening in said refrigerator, wherein at least one of said radial protrusions engages a surface of said refrigerator, and wherein said retention tab includes a retention tab receiver engaging portion between two radial protrusions;
a filter assembly housing, having a base portion with at least one retention tab receiver, having at least one tapered surface resulting in a narrowed portion, said narrowed portion configured to closely receive a surface of said retention tab receiver engaging portion of said retention tab; and
a filter unit configured to be removably coupled to said filter assembly housing.

2. The refrigerator filter assembly of claim 1, further comprising:
a Wi-Fi module coupled to said filter assembly housing and a valve coupled to said filter assembly.

3. The refrigerator filter assembly of claim 1, wherein said at least one retention tab includes an opening in the central portion of said retention tab.

4. The refrigerator filter assembly of claim 1, wherein said at least one retention tab opening is on an exterior surface of said refrigerator.

5. The refrigerator filter assembly of claim 1, wherein said base portion of said filter assembly housing includes three retention tab receivers with one of said retention tab receivers being located in a central portion of said base, and two retention tab receivers being located in portions that extend from said base.

6. The refrigerator filter assembly of claim 1, wherein said at least one retention tab receiver is raised from the bottom surface of said base portion such that said at least one retention tab receiver will be spaced apart from said surface of said refrigerator when said filter assembly housing is installed on said refrigerator.

7. The refrigerator filter assembly of claim 1, further comprising:
at least one fastener that secures said filter assembly housing to said refrigerator.

8. The refrigerator filter assembly of claim 1, wherein said filter assembly housing includes a hinged door for accessing said filter unit.

9. The refrigerator filter assembly of claim 1, wherein said at least one retention tab is made from a flexible polymeric material.

10. A filter assembly comprising:
a filter assembly housing comprising:
a base portion with at least one retention tab receiver configured for receiving a retention tab having a plurality of radial protrusions attached to an exterior surface of an appliance; and
a generally cylindrical portion for receiving a filter unit;
a filter unit removably coupled to said filter assembly housing;
a valve coupled to said filter assembly housing;
a Wi-Fi module coupled to said filter assembly housing; and
wherein said at least one retention tab receiver is spaced away from the bottom surface of said base portion to engage a portion of said retention tab that is between two of said plurality of radial protrusions.

11. The refrigerator filter assembly of claim 10, wherein said retention tab is made from a flexible material.

12. The refrigerator filter assembly of claim 11, wherein said retention tab is made from a polymeric material.

13. The refrigerator filter assembly of claim 12, wherein said retention tab includes a vertical opening in the central portion of said retention tab.

14. The refrigerator filter assembly of claim 10, further including a cover that is coupled to said filter assembly housing to permit access to said filter unit.

15. A method of installing a refrigerator filter assembly, comprising:
installing at least one retention tab into at least one retention tab opening in an exterior surface of a refrigerator cabinet, wherein said retention tab includes a plurality of radial protrusions, at least one of the radial protrusions engaging a surface of said refrigerator cabinet, and wherein at least two of the radial protrusions being spaced apart to form a retention tab receiver engaging portion;
sliding a filter assembly, having a base portion with at least one retention tab receiver over the exterior surface of said refrigerator cabinet to engage said retention tab receiver engaging portion of said at least one retention tab; and
installing a water filter into said water filter receiving portion of said base portion of said water filter assembly.

16. The method of installing a refrigerator filter assembly of claim 15, further comprising:
installing a fastener through a fastener opening in said filter assembly base portion into an opening in said refrigerator cabinet after said filter assembly sliding step.

17. The method of installing a refrigerator filter assembly of claim 16, wherein said retention tab is made from a flexible polymeric material.

18. The method of installing a refrigerator filter assembly of claim 17, wherein said retention tab further includes a vertical extending central aperture.

19. The method of installing a refrigerator filter assembly of claim 17, wherein said retention tab receiver engaging portion is spaced away from said exterior surface of said refrigerator cabinet.

20. The method of installing a refrigerator filter assembly of claim 15, wherein a Wi-Fi module and a valve are coupled to said filter assembly base.
